(19) United States
(12) Patent Application Publication
(10) Pub. No.: US 2013/0147729 A1
(43) Pub. Date: Jun. 13, 2013

(54) APPARATUS AND METHOD FOR EXECUTING MENU PROVIDED IN VEHICLE

(71) Applicant: Sang Yeon LIM, Hwaseong (KR)

(72) Inventor: Sang Yeon LIM, Hwaseong (KR)

(73) Assignees: Kia Motors Corporation, Seoul (KR); Hyundai Motor Company, Seoul (KR)

(21) Appl. No.: 13/600,797

(22) Filed: Aug. 31, 2012

(30) Foreign Application Priority Data
Dec. 13, 2011 (KR) 10-2011-0133958

(51) Int. Cl. G06F 3/041

(52) U.S. Cl. 345/173

(57) ABSTRACT

A technique of executing a menu is disclosed. More specifically, the technique includes displaying a first image on a display unit; displaying, when a plurality of touch data is simultaneously inputted through a touch pad, a plurality of menu icons on the display unit corresponding to an area in which the plurality of touch data is inputted; and executing a menu corresponding to a first menu icon, when flicking data is inputted through the touch pad with respect to the first menu icon among the plurality of menu icons. In particular, the touch pad is provided in at least one of a steering wheel, a gear knob, an operating system, a console box, a rear seat arm rest and the display unit.

### CROSS-REFERENCES TO RELATED APPLICATIONS

Priority to Korean patent application Number 10-2011-0133958, filed on Dec. 13, 2011, which is incorporated by reference in its entirety, is claimed.

### BACKGROUND OF THE INVENTION

1. Field of the Invention

The present invention relates to an apparatus and a method of executing a menu provided in a vehicle, and more particularly, to an apparatus and a method of simultaneously detecting a plurality of touch data to display a menu icon and to selectively execute a menu.

2. Description of the Related Art

Generally, when a person who is driving a vehicle has to search for a hard key provided within the vehicle to execute a predetermined menu, the driver's field of view becomes limited, and often times dangerous. Thus, often time, navigation systems utilize a touch screen to select and execute functions.

However, a vehicle system that provides various menus through a navigational touch screen is also disadvantageous in that multiple menus are stored in a systematical structure so that the user needs to move to a lower level menu several times in order to locate a function desired by the user. Also, in some instances, in order to use the navigational touch screen, the driver needs to change his or her driving position to select and execute a predetermined menu while driving since it is difficult for a passenger in a rear seat to approach the navigation.

Therefore, there is a need for a menu executing apparatus and a method thereof in which the driver may safely view and select menus while driving by using a touch data and also is capable of allowing a passenger in the backseat to execute a predetermined menu from his or her location as well.

### SUMMARY OF THE INVENTION

The present invention has been made in view of the above problems, and provides a menu executing apparatus and a method thereof in which a menu icon may be displayed according to a plurality of touch data that is simultaneously entered and a selected menu may be executed according to a flicking data.

According to an aspect of the present invention, a method of executing a menu includes displaying a first image on a display unit; displaying, in response to a controller command, when a plurality of touch data is simultaneously inputted through a touch pad, a plurality of menu icons on the display unit corresponding to an area in which the plurality of touch data is inputted; and executing, by the controller, a menu corresponding to a first menu icon, when a flicking data is inputted through the touch pad with respect to the first menu icon among the plurality of menu icons, wherein the touch pad is provided in at least one of a steering wheel, a gear knob, an operating system, a console box, a rear seat arm rest and the display unit.

According to another aspect of the present invention, an apparatus for executing a menu includes: a touch pad configured to simultaneously receive a plurality of touch data; a display unit configured to display a plurality of menu icons corresponding to an area in which the plurality of touch data is inputted; and a controller configured to execute a menu corresponding to a first menu icon when a flicking data is inputted through the touch pad with respect to the first menu icon among the plurality of menu icons. More specifically, the touch pad is provided in at least one of a steering wheel, a gear knob, an operating system, a console box, a rear seat arm rest and the display unit. More preferably the touch pad is disposed in the rear set arm rest and on the steering wheel.

According to another aspect of the present invention, a method of executing a menu includes: displaying a first image on a display unit; determining, by a controller, when a plurality of touch data is simultaneously inputted through a touch pad, when the plurality of touch data is inputted by a driver by analyzing a location in which the touch pad is provided and a pattern of the plurality of touch data; and displaying, by the controller, menu icons on the display unit corresponding to an area in which the plurality of touch data is inputted. More specifically, the touch pad is provided in at least one of a steering wheel, a gear knob, an operating system, a console box, a rear seat arm rest and the display unit.

### BRIEF DESCRIPTION OF THE DRAWINGS

The objects, features and advantages of the present invention will be more apparent from the following detailed description in conjunction with the accompanying drawings, in which:

FIG. 1 is a configuration view illustrating a menu executing apparatus according to an exemplary embodiment of the present invention;

FIG. 2 is a flow chart illustrating a menu executing method according to an exemplary embodiment of the present invention;

FIGS. 3A-3B are views illustrating a menu executing method according to an exemplary embodiment of the present invention;

FIG. 4 is a view illustrating a menu executing method according to another exemplary embodiment of the present invention; and

FIGS. 5A-B are views illustrating a location within a vehicle in which a touch pad according to the present invention can be installed.

### DETAILED DESCRIPTION OF EXEMPLARY EMBODIMENTS

Hereinafter, exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

A menu executing apparatus according to the exemplary embodiment of the present invention is provided in a vehicle to execute a menu according to a touch data entered by a driver or a passenger and a flicking data.

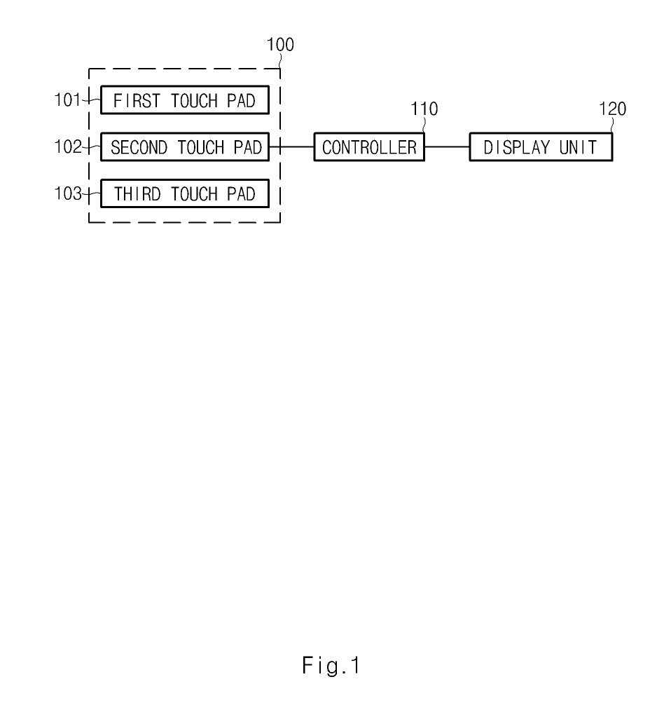

FIG. 1 is a configuration view illustrating a menu executing apparatus according to an exemplary embodiment of the present invention. As shown in FIG. 1, a menu executing apparatus includes one or more touch pads 100, a controller 110, and a display unit 120.

The touch pad 100 may be provided in, for example, a steering wheel, a gear knob, an operating system, a console box, an arm rest, or the display unit 120. More specifically, the touch pad 100 is preferably a touch screen incorporated into a navigation display screen and into the backseat armrest. Thus, a location in which the touch pad 100 can be provided is not limited to the above embodiments. Also, the number of the touch pads 100 included in the menu executing apparatus is not limited.

The touch pad 100 is a device that receives a touch data or a flicking data from a driver or a passenger. The touch pad 100 of the present invention simultaneously receives a plurality of touch data. Here, the plurality of touch data is entered by using a finger. Generally, five different pieces of touch data points may be entered at the same time. The touch pad 100 according to the present invention receives the flicking data after the touch data is entered.

The controller 110 displays menu icons on the display unit 120 according to the touch data entered through the touch pad 100. When the plurality of touch data is entered through the touch pad 100 at the same time, menu icons as many as the number of the respective touch data is displayed in an area of the display unit 120 corresponding to an area of the touch pad 100 in which the touch data is inputted. In addition, the controller 110 may display an image that represents each touch data (e.g., data points on the touch pad with is translated into command data) in addition to the menu icon. When the plurality of touch data is inputted, the menu icons may be displayed in various configurations according to a user choice.

The menu icon is an image which represents, for example, a radio, an MP3/video player, a phone dialing function, a navigation, a Digital Multimedia Broadcasting (DMB), or a phone book.

The controller 110 may display different menu icons based on the touch data entered through the touch pad. For example, menu icons displayed on the display unit 120 when the plurality of touch data is inputted through a first touch pad 101 may be different to menu icons displayed on the display unit 120 when the plurality of touch data is inputted through a second touch pad 102.

In addition, when the menu icons are displayed in response to the input touch data, the controller 110 executes a menu according to flicking data (or data points) detected by the touch pad 100. When the flicking data is entered in an area of the touch pad 100 corresponding to an area in which a first menu icon is displayed among the menu icons, the controller 110 executes a menu corresponding to the first menu icon through which the flicking data is entered. Namely, when the menu icon is displayed in response to the input touch data and the flicking data is subsequently inputted, a menu corresponding to an area through which the flicking data is entered is executed.

In addition, the controller 110 may identify which touch pad among the first touch pad 101, the second touch pad 102, and a third touch pad 103 receives the plurality of touch data points and analyze a pattern of the input touch data to identify whether the input touch data is being received by a person on the right hand side of the touch pad or the left hand side of the touch pad. Therefore, the controller 110 may determine whether the input touch data is entered by the driver based on the identified information. If it is determined that the plurality of touch data is entered by the driver during an operation of the vehicle, the controller 110 may be controlled so that a menu icon corresponding to a menu such as, for example, a digital multimedia broadcasting (DMB) or video playback is not displayed on the display unit 120 for driving safety.

In another embodiment, when it is determined that the plurality of touch data is entered by the driver during the operation of the vehicle, the controller 110 may display all menu icons that have already been preset and display in black and white a menu icon corresponding to a menu that may interfere with driving. Alternatively, the system may also not execute the menu when the flicking data is entered to the menu icon corresponding to the menu that interferes with driving.

The display unit 120 may display a currently running screen or a menu icon according to a data transmitted from the controller 110 or a screen of a menu newly executed by the controller 110. The display unit 120 may be, for example, a navigation display unit, a front seat display unit, a head-up display, or a rear seat display unit.

Thus, the menu executing apparatus according to the present invention may include one or more display units 120. For example, when the plurality of touch data may be inputted through the first touch pad 101 and the second touch pad 102, respectively, menu icons corresponding to the plurality of touch data inputted through the first touch pad 101 may be displayed on a first display unit (not shown) and menu icons corresponding to the plurality of touch data inputted through the second touch pad 102 may be displayed on a second display unit (not shown). Alternatively, a division area of one display unit may be divided so that the menu icons corresponding to the plurality of touch signals inputted through the first touch pad 101 and the menu icons corresponding to the plurality of touch signals inputted through the second touch pad 102 may be displayed on respective division areas.

On the other hand, when a plurality of menu icons are displayed in response to input touch data, the display unit 120 may display the currently running screen opaquely.

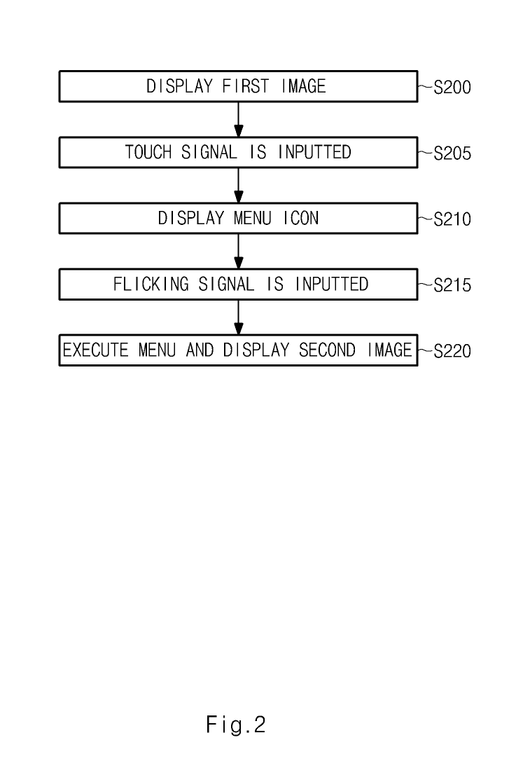

FIG. 2 is a flow chart illustrating a menu executing method according to an exemplary embodiment of the present invention. As shown in FIG. 2, a first image that is the currently running screen is displayed through the first display unit 120 (S200). For example, the first image may be a map navigation screen.

Next, a plurality of touch data is simultaneously inputted through the touch pad 100 (S205). The plurality of touch data may be inputted through one of the first touch pad 101 and the second touch pad 102.

Next, in response to the inputted plurality of the touch signals, the controller 110 displays menu icons on the display unit 120 (S210). An image that represents the input touch data may also be displayed in correspondence with the plurality of touch data. When the touch data is no longer inputted through the touch pad 100, the display unit 120 again displays the first image. Alternatively, the menu icons can be varied depending on whether the plurality of touch data is inputted through the first touch pad 101 or the second touch pad 102.

Next, when the menu icons are displayed, the flicking data is inputted through the touch pad 100 (S215). Namely, the flicking data is inputted through an area of the touch pad 100 corresponding to a second menu icon among areas in which the menu icons are displayed. The controller 110 executes a menu corresponding to the second menu icon through which the flicking data is entered and displays a second image that is a menu execution screen through the display unit 120 (S220). The menu executed by the controller 110 may be, for example, a radio, an MP3 player, a phone dialing function, a navigation, a DMB, or a phone book.

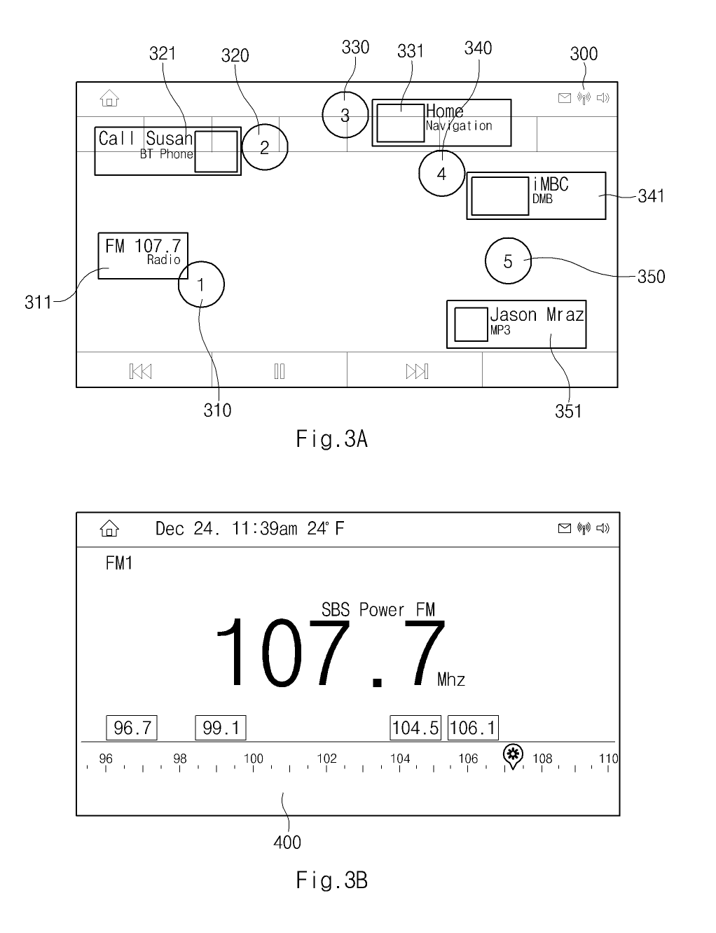

FIG. 3A-B are views illustrating a menu executing method according to an exemplary embodiment of the present invention. As shown in FIG. 3A, when five touch data points are simultaneously inputted through the touch pad 100, the display unit 120 displays five menu icons 311, 321, 331, 341 and 351 corresponding to each touch data. Images 310, 320, 330, 340 and 350 that represent the respective touch data may also be displayed with the menu icons 311, 321, 331, 341 and 351. Meanwhile, the screen 300 of the menu currently being executed is opaquely displayed.

As shown in FIG. 3B, when the five menu icons 311, 321, 331, 341 and 351 are displayed and a flicking data corresponding to one of the five menu icons is inputted, a menu corresponding to a menu icon through which the flicking data is entered is executed and a corresponding execution screen 400 is displayed.

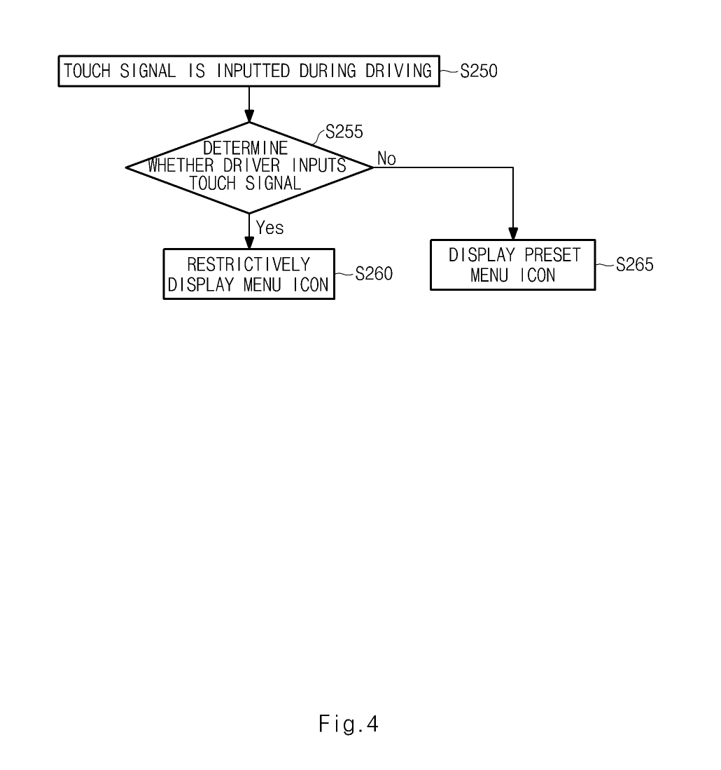

FIG. 4 is a view illustrating a menu executing method according to another exemplary embodiment of the present invention. As shown in FIG. 4, a plurality of touch data is inputted through the touch pad 100 while the vehicle is being driven (S250). The controller 110 determines whether the input touch data is entered by the driver by identifying which touch pad is receiving the touch data from the and by identifying whether the plurality of input touch data is being received from a person on the right side or the left side of the touch pad (S255).

When it is determined in step 5255 that the plurality of input touch data is entered by the driver (i.e., from the person on the right hand side of the touch pad, the controller 110 restricts the menu icons which are displayed for safe driving (S260).

On the other hand, when it is determined in step S255 that the plurality of input touch data is not entered by the driver (i.e., from a person in the back or on the left side of the touch pad, the controller 110 displays menu icons that are preset in advance (S265).

For example, in case where a Korean car being operated, when a plurality of the touch data is inputted through a touch pad provided in the console box and it is determined that the input touch signals correspond to the right hand, the touch data is entered by the driver so that the controller 110 does not display third menu icons corresponding to the menu that may interfere with driving. However, in case where a U.K. car is being operated, the touch data is determined to be entered by a passenger (on the right side) so that the controller 110 may display the preset menu icons. The inverse is true for the left side of the touch pad in regards to U.K. and Korean (or American) cars.

In an alternative embodiment, when it is determined that the plurality of input touch data is entered by the driver who is operating the vehicle, the controller 110 may display the preset menu icons while displaying in black and white the third menu icons corresponding to the menu that may interfere with driving so that, when the flicking data is entered with respect to the third menu icon, the controller 110 may not execute a menu corresponding to the third menu icon.

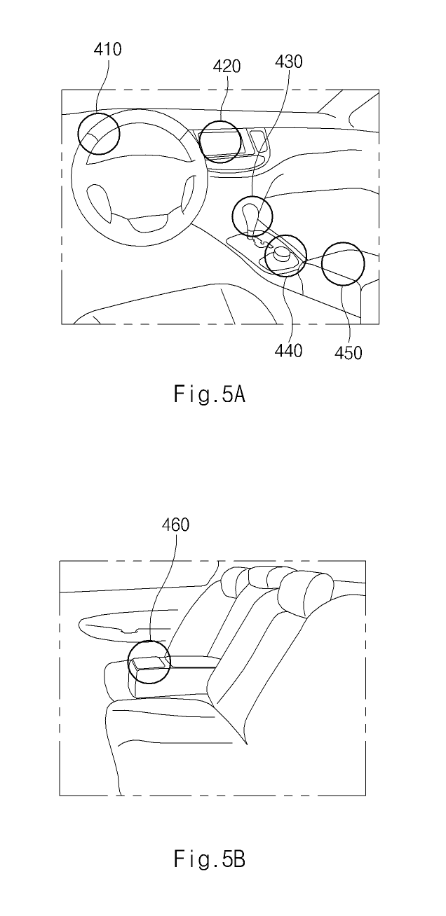

FIGS. 5A-B are views illustrating a location within a vehicle in which a touch pad according to the present invention can be installed. As shown in FIGS. 5A-B, the touch pad 100 according to the present invention may be provided in, for example, a steering wheel 410, a front seat display unit 420, a gear knob 430, an operating system 440, a console box 450 or a rear seat arm rest 460. Therefore, the passenger as well as the driver may use the menu executing apparatus of the present invention.

The present invention may be embodied as a non-transitory computer/processor readable code on a computer readable medium. The computer readable medium includes any type of recording medium that can store a data readable by the processor. Examples of the computer readable medium include ROM, RAM, CD-ROM, a magnetic tape, a floppy disk, flash drives, and an optical data storage device. However, this list is not exhaustive. The computer readable medium can also be distributed in network coupled computer systems so that the computer readable code is stored and executed in a distributed fashion through, e.g. a Controller Area Network (CAN) or a telematics server.

According to the present invention, the driver may easily identify and execute main menus that are preset in advance while driving so as to maintain safe driving conditions. Also, the touch pad according to the present invention can be mounted within various devices in the vehicle as well as the display unit so that the driver or the passenger may execute menus without changing positions or using a separate device. Further, different menu icons can be displayed depending on a location in which the touch pad is provided so that menu icons to be displayed can be set in various manners, and when it is determined that the input touch data has been entered by the driver, the menu icons are restrictively provided, thereby promoting safe driving.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of executing a menu, the method comprising:
displaying a first image on a display unit;
in response to a plurality of touch data being simultaneously inputted through a touch pad, displaying a plurality of menu icons on the display unit corresponding to an area in which the plurality of touch data is inputted; and
executing, by a controller, a menu corresponding to a first menu icon, when a flicking data is inputted through the touch pad with respect to the first menu icon among the plurality of menu icons,
wherein the touch pad is provided in at least one of a steering wheel, a gear knob, an operating system, a console box, a rear seat arm rest and the display unit.

2. The method according to claim 1, wherein the plurality of menu icons are different from one another depending on a location in which the touch pad is provided.

3. The method according to claim 1, wherein the first image is opaquely displayed during when the plurality of menu icons are displayed.

4. The method according to claim 1, further comprising
displaying a second image produced by executing the menu on the display unit.

5. The method according to claim 1, wherein the display unit is at least one of a navigation, a front seat display unit, a head up display, and a rear seat display unit.

6. An apparatus for executing a menu, the apparatus comprising:
a touch pad configured to simultaneously receive a plurality of touch data;
a display unit configured to display a plurality of menu icons corresponding to an area in which the plurality of touch data is inputted; and
a controller configured to execute a menu corresponding to a first menu icon when flicking data is inputted through the touch pad with respect to the first menu icon among the plurality of menu icons,
wherein the touch pad is provided in at least one of a steering wheel, a gear knob, an operating system, a console box, a rear seat arm rest and the display unit.

7. The apparatus according to claim 6, wherein the plurality of menu icons are different from one another depending on a location in which the touch pad is provided.

8. The apparatus according to claim 6, wherein the display unit is at least one of a navigation, a front seat display unit, a head up display, and a rear seat display unit.

9. The apparatus according to claim 6, wherein the display unit is configured to display a second image produced by executing the menu on the display unit.

10. A method of executing a menu, the method comprising:
displaying a first image on a display unit;
determining, by a controller, when a plurality of touch data is simultaneously inputted through a touch pad, that the plurality of touch data is inputted by a person who is driving the vehicle by analyzing a location in which the touch pad is provided and a pattern related to the plurality of touch data; and
displaying, by the controller, menu icons on the display unit corresponding to an area in which the plurality of touch data is inputted,
wherein the touch pad is provided in at least one of a steering wheel, a gear knob, an operating system, a console box, a rear seat arm rest and the display unit.

11. The method according to claim 10, wherein, when a determination result is such that the touch data is inputted by the person who is driving, a menu icon corresponding to a menu that potentially interferes with driving is excluded from the menu icons.

12. The method according to claim 10, wherein, when a determination result is such that the touch data is inputted by the person who is driving, the controller displays a menu icon corresponding to a menu that potentially interferes driving in black and white.

13. The method according to claim 12, further comprising:
executing, by the controller, a first menu corresponding to a first menu icon when flicking data is inputted through the touch pad with respect to the first menu icon,
wherein the controller is not configured to execute the first menu when the first menu icon is displayed in black and white.

14. A non-transitory computer readable medium containing program instructions executed by a processor or controller, the computer readable medium comprising:
program instructions that display a first image on a display unit;
program instructions that display a plurality of menu icons on the display unit corresponding to an area in which the plurality of touch data is inputted in response to a plurality of touch data being simultaneously inputted through a touch pad,; and
program instructions that execute a menu corresponding to a first menu icon, when a flicking data is inputted through the touch pad with respect to the first menu icon among the plurality of menu icons,
wherein the touch pad is provided in at least one of a steering wheel, a gear knob, an operating system, a console box, a rear seat arm rest and the display unit.
